(19) United States
(12) Patent Application Publication
(10) Pub. No.: US 2016/0274248 A1
(43) Pub. Date: Sep. 22, 2016

(54) REFLECTOR MATERIAL, SCINTILLATOR ARRAY, METHOD OF MANUFACTURING SCINTILLATOR ARRAY, AND RADIATION DETECTOR

(71) Applicant: KABUSHIKI KAISHA TOSHIBA, Minato-ku (JP)

(72) Inventors: Hitoshi HASEGAWA, Yokohama (JP); Seiichiro MURAI, Yokohama (JP); Tomomi YOKOI, Wako (JP)

(73) Assignee: KABUSHIKI KAISHA TOSHIBA, Minato-ku (JP)

(21) Appl. No.: 15/054,662

(22) Filed: Feb. 26, 2016

(30) Foreign Application Priority Data
Mar. 18, 2015 (JP) 2015-055255

(51) Int. Cl. G01T 1/20; G02B 1/04; G01T 1/202; G02B 5/08

(52) U.S. Cl. CPC G01T 1/2002; G02B 5/0891; G02B 1/04; G01T 1/202; G01T 1/2018

(57) ABSTRACT

According to an embodiment, a scintillator array includes a plurality of scintillator crystals arranged two-dimensionally so as to be separated by a gap, and a reflector material formed in the gap between the scintillator crystals. The reflector material contains reflective particles selected from the group consisting of barium sulfate, aluminum oxide and polytetrafluoroethylene, and straight silicone as a binder.

### CROSS REFERENCE TO RELATED APPLICATIONS

This application is based upon and claims the benefit of priority from Japanese Patent Application No. 2015-055255, filed Mar. 18, 2015, the entire contents of which are incorporated herein by reference.

### FIELD

Embodiments described herein relate to a reflector material, a scintillator array, a method of manufacturing a scintillator array, and a radiation detector.

### BACKGROUND

A scintillator is a substance which emits light (scintillation light) in accordance with incidence of radiation. For a radiation detector, a scintillator array is used in which a plurality of scintillator crystals processed into columns are arranged two-dimensionally in a matrix shape and a reflector material is formed in the gap between the scintillator crystals.

Recently, scintillator crystals which emit light in the emission wavelength region between 350 nm and 450 nm have been used. Thus, such scintillator arrays and radiation detectors are required to enhance utilization efficiency for light having a wavelength between 350 nm and 450 nm.

The problem to be solved by the present invention is to provide a reflector material, a scintillator array and a radiation detector with high utilization efficiency for light having a wavelength between 350 nm and 450 nm.

### BRIEF DESCRIPTION OF THE DRAWINGS

FIG. 1 is a perspective view of a scintillator array according to an embodiment;

FIG. 2 is a schematic view illustrating a radiation detector according to an embodiment;

FIG. 3 is a cross-sectional view of a scintillator array according to an embodiment;

FIG. 4 is a cross-sectional view of a reflector material according to an embodiment, in which reflective particles having a single average particle size are dispersed;

FIG. 5 is a cross-sectional view of a reflector material according to an embodiment, in which reflective particles having two average particle sizes are dispersed;

FIG. 6 is a view showing a relationship between mixing ratios of reflective particles in the reflector materials according to embodiments and reflectances thereof;

FIG. 7 is a graph showing transmission spectra of four types of reflector materials;

FIG. 8 is a graph showing absorption spectra of four types of reflector materials; and

FIG. 9 is a graph showing reflection spectra of six types of reflector materials.

### DETAILED DESCRIPTION

Hereinafter, embodiments will be described.

According to an embodiment, a scintillator array includes a plurality of scintillator crystals arranged two-dimensionally so as to be separated by a gap, and a reflector material formed in the gap between the scintillator crystals. The reflector material contains reflective particles selected from the group consisting of barium sulfate, aluminum oxide and polytetrafluoroethylene, and straight silicone as a binder.

FIG. 1 shows a perspective view of a scintillator array according to an embodiment. The scintillator array 10 in FIG. 1 includes: a plurality of scintillator crystals 11 processed into columns and arranged two-dimensionally in a matrix shape so as to be separated by a gap; and a reflector material 12 formed in the gap between the scintillator crystals 11. The reflector material 12 contains reflective particles selected from the group consisting of barium sulfate, aluminum oxide and polytetrafluoroethylene, and straight silicone as a binder.

The scintillator crystals 11 preferably emit light in the wavelength region between 350 nm and 450 nm in accordance with incidence of radiation. The reflective particles constituting the reflector material 12 preferably exhibit high reflectance for light having a wavelength between 350 nm and 450 nm. The binder constituting the reflector material 12 preferably exhibits low absorptance and high transmittance for light having a wavelength between 350 nm and 450 nm.

A radiation detector according to an embodiment includes the above-described scintillator array and a photodetector such as a photodiode.

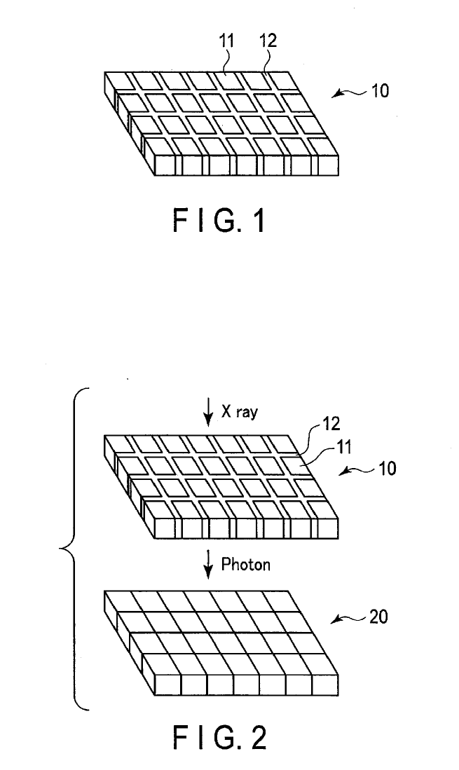

The radiation detector according to the embodiment will be described schematically with reference to FIG. 2.

On the light emission side of the scintillator array 10, a photodetector 20 such as a photodiode is arranged. Usually, the scintillator array 10 and the photodetector 20 are integrated so as to constitute a detector pack for a radiation detector.

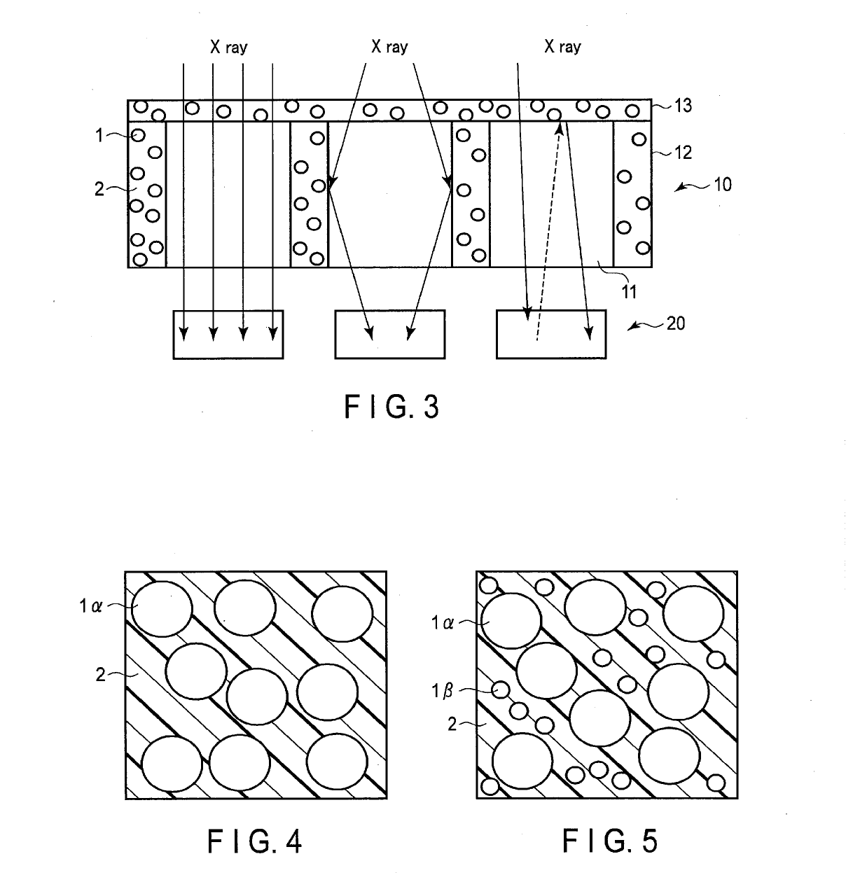

FIG. 3 shows a cross-sectional view of the scintillator array 10 according to an embodiment. In this figure, a surface reflector material 13 is formed on a radiation incident-side surface of the scintillator array 10 including the scintillator crystals 11 and the reflector material 12 formed in the gap between the scintillator crystals 11. The components for the surface reflector material 13 may be the same as those for the reflector material 12 in the gap between the scintillator crystals 11.

Although the surface reflector material 13 is not necessarily provided, the provision of the surface reflector material 13 can enhance the utilization efficiency of light. More specifically, as shown in FIG. 3, light emitted from the scintillator crystals 11 in accordance with incidence of radiation travels rectilinearly to reach the photodetector 20, or is reflected by the reflector material 12 to reach the photodetector 20, but a part of the light is reflected by, for example, a surface of the photodetector 20 to return to the radiation incident side. If the surface reflector material 13 is provided, the light that returns to the radiation incident side can be detected by the photodetector 20, whereby the utilization efficiency of light can be enhanced.

Next, materials used for the scintillator array according to the embodiment will be described.

Examples of a material suitable for the scintillator crystal 11, which emits light in a wavelength region between 350 nm and 450 nm in accordance with the incidence of radiation, include: NaI:Tl (thallium-activated sodium iodide); CsI:Na (sodium-activated cesium iodide); CsF₂:Eu (europium-activated cesium fluoride); CsF (cesium fluoride); LiF:W (tungsten-activated lithium fluoride); PbWO₄ (lead tungstate, PWO); Y₂SiO₅:Ce (cerium-activated yttrium silicate, YSO); Gd₂SiO₅:Ce (cerium-activated gadolinium silicate, GSO); Lu₂SiO₅:Ce (cerium-activated lutetium silicate, LSO); (Lu, Gd)₂SiO₅:Ce (cerium-activated lutetium gadolinium silicate, LGSO); (Lu, Y)₂SiO₅:Ce (cerium-activated lutetium yttrium silicate, LYSO).

The reflector material contains reflective particles and straight silicone as a binder. The reflector material can be formed by: filling a liquid composition containing the reflective particles and the straight silicone into the gap between the scintillator crystals; and curing the straight silicone.

The reflective particles constituting the reflector material are selected from the group consisting of: barium sulfate; aluminum oxide; and polytetrafluoroethylene. These reflective particles exhibit high reflectance for light having a wavelength between 350 nm and 450 nm.

The straight silicone as the binder constituting the reflector material is selected from the group consisting of: dimethyl silicone; methyl phenyl silicone and methyl hydrogen silicone. Structures of dimethyl silicone, methyl phenyl silicone and methyl hydrogen silicone will be shown by means of following chemical formulas.

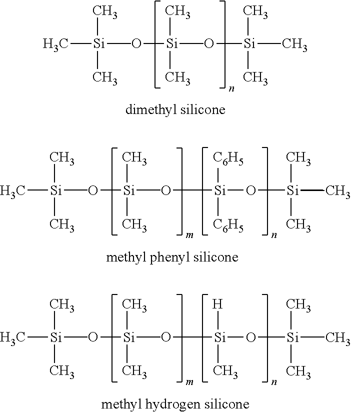

Dimethyl silicone has a structure in which all of side chains and terminal groups of polysiloxane, —(Si—O—Si—O)—, are methyl groups (CH₃).

Methyl phenyl silicone has a structure in which some of the side chains of polysiloxane, —(Si—O—Si—O)—, are phenyl groups (C₆H₅). Methyl phenyl silicone preferably contains phenyl groups (C₆H₅) at a content ratio between 5% and 35% with respect to all of organic groups bonded to Si atoms of polysiloxane. The phenyl group (C₆H₅) content ratio of more than 35% is not preferable because the absorption wavelength of the cured product is shifted toward a longer wavelength.

Methyl hydrogen silicone has a structure in which some of the side chains of polysiloxane, —(Si—O—Si—O)—), are hydrogen (H). Methyl hydrogen silicone preferably contains hydrogen (H) at a content ratio between 5% and 35% with respect to all of the organic groups bonded to the Si atoms of polysiloxane. The hydrogen (H) content ratio of more than 35% is not preferable because a curing rate is reduced.

The above-described straight silicone exhibits low absorptance and high transmittance for light having a wavelength between 350 nm and 400 nm, because only C and H atoms are contained in its side chains and absorption peak thereof exists on a shorter wavelength side (around 300 nm) in a ultraviolet region.

Whereas, besides the straight silicone, so-called modified silicone is known as the silicone. Modified silicone includes: a side chain-modified type in which an organic group is introduced into a side chain of polysiloxane; an one terminal-modified type in which an organic group is introduced into one terminal of polysiloxane; a both terminals-modified type in which organic groups are introduced into both terminals of polysiloxane; and a side chain, both terminals-modified type in which organic groups are introduced into a side chain and both terminals of polysiloxane. These types of modified silicone do not exhibit low absorptance or high transmittance for light having a wavelength between 350 nm and 400 nm, because the various types of organic groups are bonded thereto, and their absorption peaks are accordingly shifted toward a longer wavelength.

When forming the reflector material by curing the liquid composition comprising the reflective particles and the straight silicone, forms of use include one-component type and two-component type; curing conditions include room-temperature curing and thermal curing; and reaction mechanisms include a condensation reaction type and an addition reaction type, which are used in combination as appropriate.

In the condensation reaction type, curing reaction proceeds while generating a reaction by-product (outgas). In the one-component condensation reaction type, curing reaction is caused by water in the air, and the curing proceeds from the surface of the liquid composition in contact with the air toward the depth direction. In the two-component condensation reaction type, the curing reaction is caused by addition of a curing agent to polysiloxane that is a main agent, so that the curing proceeds in the whole liquid composition. The curing agent contains a functional group that functions similarly to water. Here, for the curing in the condensation reaction type, water is necessary in either of the one-component type and the two-component type. The outgas, the by-product, of the two-component condensation reaction type includes, for example, ethanol or acetone.

In the two-component addition reaction type, for example, polysiloxane having a vinyl group (CH₂═CH—) as the main agent and polysiloxane having a hydroxyl group (HO—) as the curing agent are subjected to a hydroxylation reaction in the presence of a platinum group metal catalyst so as to be cured. In the two-component addition reaction type, a reaction rate, that is, a curing time can be controlled by means of an amount of the curing agent and a type of the catalyst to be used.

In the one-component addition reaction type, polysiloxane is heated in the presence of a platinum group metal catalyst so as to be cured.

As the platinum group metal catalyst, platinum-based, palladium-based and rhodium-based catalysts and the like are exemplified, and in particular, the platinum-based catalyst is preferably used in the light of economy and reactivity. As the platinum-based catalyst, known catalysts can be used. More specifically, platinum fine powder, platinum black, chloroplatinic acid such as tetrachloroplatinic (II) acid and hexachloroplatinic (IV) acid, platinum (IV) chloride, an alcohol compound and an aldehyde compound of chloroplatinic acid, an olefin complex, an alkenylsiloxane complex and a carbonyl complex of platinum, and the like are exemplified.

An example of the reaction of the straight silicone will be described more specifically. Here, a reaction of crosslinking organopolysiloxane that contains:

organopolysiloxane having alkenyl groups at both terminals and/or in side chains (hereinafter, also called as organopolysiloxane A as appropriate); and
organopolysiloxane having hydrosilyl groups at both terminals and/or in side chains (hereinafter, also called as organopolysiloxane B as appropriate) will be described.

The alkenyl group is not limited particularly, and includes, for example, a vinyl group (an ethenyl group), an allyl group (a 2-propenyl group), a butenyl group, a pentenyl group, a hexenyl group. Among them, a vinyl group is preferable in view of excellent heat resistance.

As a group other than the alkenyl group contained in the organopolysiloxane A and a group other than the hydrosilyl group contained in the organopolysiloxane B, an alkyl group (in particular, an alkyl group having four carbons or less) is exemplified.

A position of the alkenyl group in the organopolysiloxane A is not limited particularly. In the case where the organopolysiloxane A is a straight chain, the alkenyl group may be present in either of an M unit and a D unit as described below, and may be present in both of the M unit and the D unit. In the light of the curing rate, it is preferable that the alkenyl group is present at least in the M unit and that the alkenyl groups are present in both of the two M units.

Incidentally, the M unit and the D unit are examples of basic constitutional units of organopolysiloxane, where the M unit is a siloxane unit having one functionality to which three organic groups are bonded, and the D unit is a siloxane unit having two functionalities to which two organic groups are bonded. In the siloxane unit, since the siloxane bond is a bond in which two silicon atoms are bonded to each other via one oxygen atom, the number of oxygen atoms per one silicon atom in the siloxane bond is assumed to be ½, which is expressed as O_{1/2} in the following formulas.

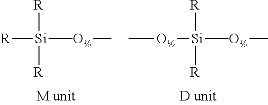

The number of alkenyl groups in the organopolysiloxane A is not limited particularly. Having one to three alkenyl groups in one molecule is preferable and having two alkenyl groups in one molecule is more preferable.

A position of the hydrosilyl group in the organopolysiloxane B is not limited particularly. In the case where the organopolysiloxane B is a straight chain, the hydrosilyl group may be present in either of the M unit and the D unit, and also may be present in both of the M unit and the D unit. In the light of the curing rate, the hydrosilyl group is preferably present at least in the D unit.

The number of the hydrosilyl groups in the organopolysiloxane B is not limited particularly. Having at least three hydrosilyl groups in one molecule is preferable and having three hydrosilyl groups in one molecule is more preferable.

A mixing ratio between the organopolysiloxane A and the organopolysiloxane B is not limited particularly. It is preferable to prepare a mixture so that a molar ratio between hydrogen atoms bonded to the silicon atoms in the organopolysiloxane B and all of the alkenyl groups in the organopolysiloxane A (the hydrogen atoms/the alkenyl groups) be within a range between 0.7 and 1.05. In particular, it is preferable to prepare the mixture so that the mixing ratio be within a range between 0.8 and 1.0.

As the hydrosilylation catalyst, the platinum group metal catalyst is preferably used. An amount of the hydrosilylation catalyst to be used is preferably within a range between 0.1 parts by weight and 20 parts by weight, and is more preferably within a range between 1 part by weight and 10 parts by weight with respect to 100 parts by weight of a total weight of the organopolysiloxane A and the organopolysiloxane B.

Particle sizes of the reflective particles in the reflector material of the embodiment will be described with reference to FIGS. 4 and 5.

In the reflector material in FIG. 4, reflective particles 1α having a single average particle size are dispersed in the binder 2. Particle size distribution of the reflective particles 1α is unimodal.

In the reflector material in FIG. 5, the reflective particles 1α and reflective particles 1β having two average particle sizes are dispersed in the binder 2. Particle size distribution of the reflective particles 1α and the reflective particles 1β is bimodal. Also, the particle size distribution of the reflective particles may be multimodal.

In the case of using the reflective particles having two or more average particle sizes, a mixing ratio and a packing density of the reflective particles in the reflector material can be increased, which contributes to improvement in the reflectance.

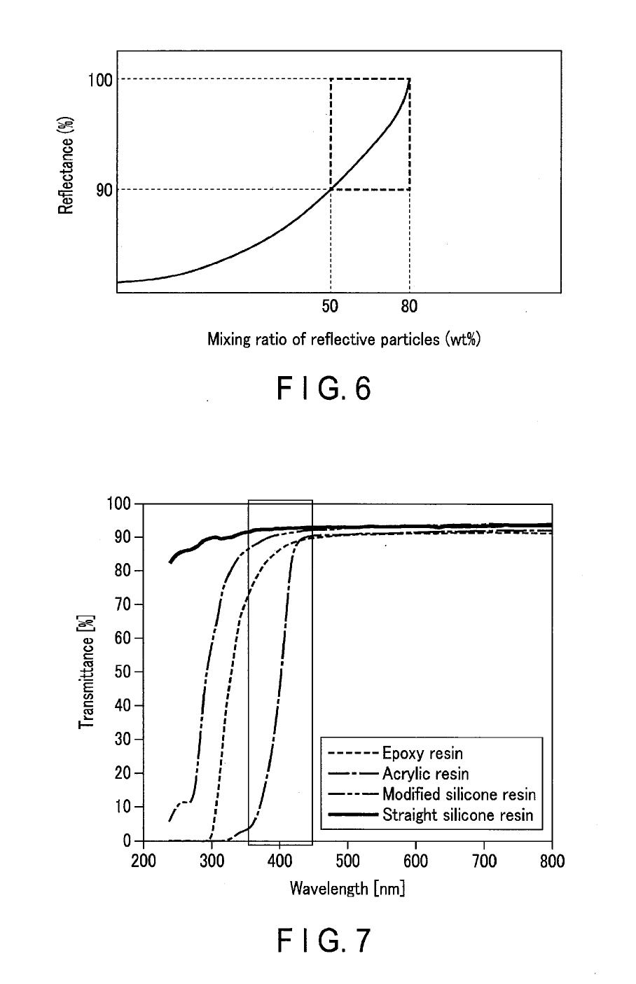

FIG. 6 shows a relationship between the mixing ratios of the reflective particles in the reflector materials of the embodiments and reflectances thereof. A preferable particle system in the reflector material of the embodiment will be described with reference to the drawing.

The reflector material of the embodiment exhibits practical reflectance of 90% or more in the case where the mixing ratio of the reflective particles with respect to the entire reflector material is 50 wt % or more.

Whereas, according to a document, Journal of the Japan Institute of Metals, Vol. 50, No. 5, 1986, pp. 475-479, in a binary particle system with different particle sizes, a packing density varies depending on a particle size ratio and a mixing ratio, and becomes maximum when the mixing ratio of the particles is around 0.72. Further, in the reflector material of the embodiment, an upper limit of the mixing ratio of the reflective particles with respect to the entire reflector material is 80 wt % in light of a limit of physical mixing of the reflective particles and the binder and adhesive strength.

If the mixing ratio of the reflective particles with respect to the entire reflector material is within a range between 50 wt % and 80 wt %, the reflectance of 90% or more can be exhibited, and sufficient adhesive strength can also be obtained.

The particle sizes of the reflective particles used for the reflector material of the embodiment is preferably within a range between 0.5 μm and 20 μm. In the case of using the two types of the reflective particles with the different average particle sizes, the average particle size of the smaller reflective particles 1β are preferably ⅕ or less of the average particle size of the larger reflective particles 1α. In the case of using the two types of reflective particles with the different average particle sizes, it is preferable to set so that the mixing ratio of the larger reflective particles 1α with respect to the entire reflector material may be within a range between 40 wt % and 50 wt %, and the mixing ratio of the smaller reflective particles 1β with respect to the entire reflector material may be within a range between 10 wt % and 20 wt %.

Next, an example of a method of manufacturing a scintillator array according to the embodiment will be described.

A scintillator crystal block is diced with a blade from the upper surface thereof to form a lattice-shaped groove for dividing gap, so that formed is a structure in which scintillator crystals processed into columns are arranged two-dimensionally in a matrix shape. The gap between the scintillator crystals is impregnated with a liquid composition comprising reflective particles and straight silicone. An excessive liquid composition is removed with a squeegee. The thus obtained scintillator crystal block is put into a vacuum vessel, which is subjected to vacuum drawing to remove bubbles from the liquid composition. These operations are repeated, so that the liquid composition is filled into the gap between the columnar scintillator crystals. Then, by curing the liquid composition, the reflector material between the columnar scintillator crystals is formed. Thereafter, the upper surface and bottom surface of the scintillator crystal block is grinded, thereby manufacturing the scintillator array according to the embodiments.

Also, as described above with reference to FIG. 3, the surface reflector material 13 may be formed by applying the liquid composition comprising the reflective particles and the straight silicone onto a radiation incident-side surface of the scintillator array 10 and curing the liquid composition.

Further, the thus obtained scintillator array 10 is connected to a photodetector 20 such as a photodiode, thereby manufacturing a radiation detector.

### EXAMPLES

Hereinafter, examples will be described.

### Example 1

Reflector materials (A) to (D) were produced using following reflective particles and binders.

(A) Reflective particles: titanium oxide with an average particle size of 10 μm, and binder: epoxy resin.

(B) Reflective particles: barium sulfate with an average particle size of 10 μm, and binder: acrylic resin.

(C) Reflective particles: barium sulfate with an average particle size of 10 μm, and binder: modified silicone resin.

(D) Reflective particles: barium sulfate with an average particle size of 10 μm, and binder: straight silicone resin (dimethyl silicone resin).

The straight silicone is a two-component type. A mixing ratio of the reflective particles in each reflector material was set to 60 wt %.

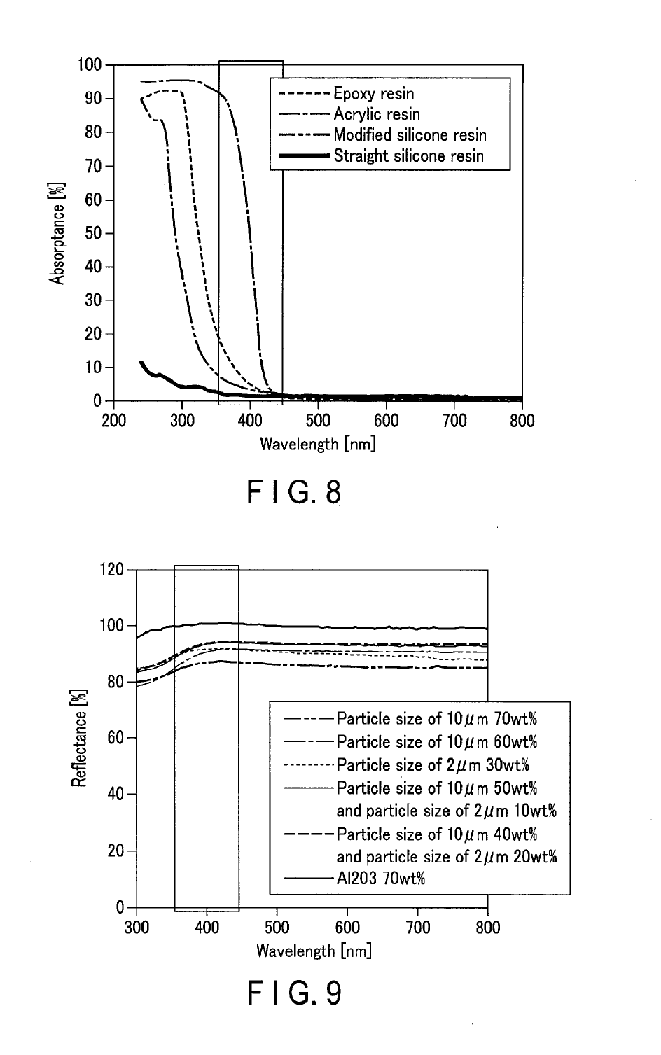

FIG. 7 shows transmission spectra of the obtained four types of reflector materials. FIG. 8 shows absorption spectra of the obtained four types of reflector materials.

It is found followings from FIGS. 7 and 8. The reflector material (D) containing straight silicone (dimethyl silicone) as the binder exhibited transmittance of 90% or more and absorptance of 5% or less in the wavelength region between 350 nm and 450 nm. The reflector material (C) containing modified silicone as the binder exhibited transmittance of 85% or more and absorptance of about 8% in the wavelength region between 350 nm and 450 nm. The reflector material (A) or (B) containing epoxy resin or acrylic resin as the binder exhibited further lower transmittance and higher absorptance. Thus, the reflector material (D) containing straight silicone (dimethyl silicone resin) as the binder can contribute to improvement in the reflectance of the reflector material in the wavelength region between 350 nm and 450 nm.

### Example 2

As described below, reflector materials (D) to (I) were produced using reflective particles having one average particle size or two average particle sizes with a variation of mixing ratios of the reflective particles. For the reflector materials (D) to (H), same two-component type straight silicone (dimethyl silicone) was used. For the reflector material (I), one-component type straight silicone (dimethyl silicone) was used.

(D) Reflective particles: 60 wt % of barium sulfate with an average particle size of 10 μm (the same as the reflector material (D) in Example 1).

(E) Reflective particles: 70 wt % of barium sulfate with an average particle size of 10 μm.

(F) Reflective particles: 30 wt % of barium sulfate with an average particle size of 2 μm.

(G) Reflective particles: 50 wt % of barium sulfate with an average particle size of 10 μm and 10 wt % of barium sulfate with an average particle size of 2 μm.

(H) Reflective particles: 40 wt % of barium sulfate with an average particle size of 10 μm and 20 wt % of barium sulfate with an average particle size of 2 μm.

(I) Reflective particles: 70 wt % of aluminum oxide with an average particle size of 10 μm.

FIG. 9 shows reflection spectra of the obtained six types of the reflector materials. It is found from FIG. 9 that, if the reflective particles are the same (barium sulfate), the reflector materials (G) and (H) containing the reflective particles having two average particle sizes tend to exhibit higher reflectance in the wavelength region between 350 nm and 450 nm than those of the reflector materials (D), (E) and (F) each of which contains the reflective particles having one average particle size. It is considered that the reason for this is because packing densities become higher when used is the reflector material containing two types of reflective particles having different average particle sizes.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reflector material comprising:
reflective particles selected from the group consisting of barium sulfate, aluminum oxide and polytetrafluoroethylene; and
straight silicone.

2. The reflector material according to claim 1, wherein a ratio of the reflective particles in the reflector material ranges from 50 wt % to 80 wt %.

3. The reflector material according to claim 1, wherein the reflector material contains two or more types of reflective particles having different average particle sizes.

4. A scintillator array comprising:
a plurality of scintillator crystals arranged two-dimensionally so as to be separated by a gap; and
the reflector material according to claim 1 formed in the gap between the scintillator crystals.

5. The scintillator array according to claim 4, further comprising a surface reflector material on a surface of the plurality of scintillator crystals.

6. A method of manufacturing a scintillator array, comprising:
dicing a scintillator crystal block to provide a lattice-shaped groove, thereby forming a structure in which a plurality of scintillator crystals processed into columns are arranged two-dimensionally in a matrix shape;
filling a liquid composition comprising: reflective particles selected from the group consisting of barium sulfate, aluminum oxide and polytetrafluoroethylene; and straight silicone, into a gap between the scintillator crystals; and
curing the liquid composition to form a reflector material between the scintillator crystals.

7. The method according to claim 6, wherein the liquid composition is a one-component type or a two-component type, and is cured by a condensation reaction or an addition reaction.

8. The method according to claim 6, wherein a platinum group metal catalyst is used for curing the liquid composition.

9. A radiation detector comprising:
the scintillator array according to claim 4; and
a photodetector.
